(19) United States
(12) Patent Application Publication
(10) Pub. No.: US 2015/0185308 A1
(43) Pub. Date: Jul. 2, 2015

(54) IMAGE PROCESSING APPARATUS AND IMAGE PROCESSING METHOD, IMAGE PICKUP APPARATUS AND CONTROL METHOD THEREOF, AND PROGRAM

(71) Applicants: Katsuhiro Wada, Tokyo (JP); Yohei Horikawa, Tokyo (JP)

(72) Inventors: Katsuhiro Wada, Tokyo (JP); Yohei Horikawa, Tokyo (JP)

(21) Appl. No.: 14/146,218

(22) Filed: Jan. 2, 2014

(51) Int. Cl. G01S 3/786

(52) U.S. Cl. CPC G01S 3/7864

(57) ABSTRACT

An image pickup apparatus including an image pickup unit including a two-dimensional, pixel array, and a photographing optical system including a tonus lens and a microlens array arranged between the image pickup unit and the focus lens, where each microlens corresponds to one of division blocks provided in case the two-dimensional pixel array is divided on a unit basis of a block including a predetermined number of pixels, detects an object included in a photographing image based on the readout pixel signals and controls, based on the object detection result, the reduction amount of the pixel signals read out from a division block corresponding to a detection area of the detected object in the photographing image and the reduction amount of the pixel signals read out from a division block corresponding to an area other than the defection area.

### BACKGROUND OF THE INVENTION

1. Field of the Invention

The present invention relates to an image pickup apparatus and, more particularly, to an image pickup apparatus that picks up an optical image of an object and obtains and processes light field data, and a control method thereof.

2. Description of the Related Art

There is known, for example, an image pickup apparatus that arranges, in front of a plurality of pixels of an image pickup element, a microlens array (MLA) provided with one microlens corresponding to a predetermined number of pixels, thereby obtaining not only the two-dimensional intensity distribution of light but also the information of the incident direction of rays entering the image pickup element. Such an image pickup apparatus capable of obtaining the three-dimensional information of an object space is called a light field camera (to be referred to as an LF camera hereinafter). The three-dimensional information of the object space is called light field data (to be referred to as LF data hereinafter). When an image re-formation process using LF data is performed after photographing, an image process called refocusing such as changing the focusing point of an image, changing the photographing viewpoint, and adjusting the depth of field can be performed.

FIG. 11 is a view showing an example of an arrangement that implements a focusing function of obtaining the three-dimensional information of an object space in an LF camera.

Referring to FIG. 11, MLs 1104 are arranged on an image plane 1103. An image pickup element 1106 including a plurality of photoelectric conversion elements 1105 is arranged on a plane behind the MLA of the MLs 1104. Light condensed by a focus lens 1102 is projected to the MLs 1104 arranged on the image plane 1103.

In the LF camera that is an image pickup apparatus having such a structure, rays from an object 1101 which are projected onto the MLs 1104 are divided by the ML 1104 and projected onto the pixels (photoelectric conversion elements) 1105 corresponding to the MLs. Hence, the information of the image formed on the image pickup element 1106 includes the information of she plurality of ray orientations. In this way, pixel data (LF data) obtained as a result of image formation on the image pickup element by the focusing function of the LF camera enables refocusing of a recorded image since the pixel data have a plurality of different parallaxes.

Letting N be the number, of pixels of the image pickup element, and M be the number of divisions (number of pixels) of an image divided by one ML, the number LFDATA (number of pixels) of pickup pixel data obtained by the above-described LF camera is given by

LFDATA=N×M

Note that in FIG. 11, the number M of pixels (to be referred to as division pixels hereinafter) divided at least in a direction parallel to the imaging plane of the image pickup element 1106 is 4.

As described above, the amount of pickup pixel data obtained by the LF careers increases in accordance with the number of divisions. In the image pickup apparatus having the focusing function of enabling LF data obtaining, the process load increases upon performing various kinds of signal processes for the pickup pixel data. Additionally, when loading the pickup pixel data to various kinds of image signal processing means, a data storage means having a large capacity is necessary.

As a result, power consumption increases along with the increase in the data process load, and the capacity of tine data storage means increases along with the increase in the process data amount, thus leading to an increase in the cost.

As for data amount reduction, a method of adding pixel outputs in the image pickup element so as to reduce the amount of pixel data to be processed has been considered (for example, Japanese Patent Application Laid-Open No. 2009-3122).

In the image pickup apparatus having the focusing function of the LF camera, however, when one amount of pixel data to be processed is reduced by pixel addition in the image pickup element, the following problem arises. Since information necessary for refocusing is also lost by the reduction of the pixel data amount, the refocusing range becomes shallow when refocusing a photographed image at the time of reproduction.

The present invention has been made in consideration of the above-described problem, and provides an LF camera capable of reducing the amount of data to be processed by various kinds of image signal processing means and also reducing the capacity of a means for storing the data white keeping the refocusing range at the time of refocusing after photographing.

### SUMMARY OF THE INVENTION

The present invention provides an image pickup apparatus including an image pickup unit including a two-dimensional array of a plurality of pixels each of which converts an optical image into a pixel signal by photoelectric conversion, and a photographing optical system including a focus lens, and an ML array formed from a plurality of MLs arranged between the image pickup unit and the focus lens, each ML corresponding to one of division blocks provided in case the two-dimensional array of the pixels is divided on a unit basis of a block including a predetermined number of pixels, comprising a readout unit configured to read out the pixel signals from the plurality of pixels, an object detection unit configured to detect an object included in a photographing picture image based on the pixel signals read out by the readout unit, and a control unit configured to control the readout unit based on a result of object detection by the object detection unit, and variably controls a reduction amount of the pixel signals read out from a division block corresponding to a detection area of the detected object in the photographing picture image and the reduction amount of the pixel signals read out from a division block corresponding to an area other than the detection area.

Further features of the present invention will become apparent from the following description of exemplary embodiments with reference to the attached drawings.

### BRIER DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram showing the arrangement of an image pickup apparatus according to the first embodiment of the present inventions.

FIG. 2 is a view showing the division pixel arrangement of the image pickup apparatus according to the first embodiment of the present invention and an image picked up.

FIG. 3 is a flowchart showing the image pickup operation of the image pickup apparatus according to the first embodiment of the present invention.

FIGS. 4A, 4B and 4C are views showing addition or division pixel data in the image pickup apparatus according to the first embodiment of the present invention.

FIG. 5 is a view showing an object detection area in a frame image picked up.

FIG. 6 is a flowchart showing another image pickup operation of the image pickup apparatus according to the first embodiment of the present invention.

FIG. 7 is a view showing a plurality of object detection areas in a frame image picked up.

FIG. 8 is a flowchart showing an image pickup operation according to the second embodiment of the present invention.

FIG. 9 is a view showing division or a frequency area in a frame image according to the second embodiment of the present invention.

FIGS. 10A and 10B are views showing addition of division pixel data in an image pickup apparatus according to the second embodiment of the present invention.

FIG. 11 is a view allowing an example of an LF arrangement that implements the focusing function of an LF camera.

FIG. 12 is a view for explaining pixel data according to a modification of the first or second embodiment of the present invention.

FIG. 13 is a view for explaining a pixel data readout area according to the modification of the first or second embodiment of the present invention.

FIG. 14 is a block diagram showing the arrangement of an image pickup apparatus according to the third embodiment of the present invention.

FIG. 15 is a view for explaining a unit pixel cell of an image pickup element used in the image pickup apparatus according to the third embodiment of the present invention arid an image obtained by the division pixels.

FIGS. 16A and 16B are views showing an object positron and an object detection range.

FIG. 17 is a view showing an object position and the influence of blur when performing object estimation.

FIG. 18 is a view showing the positrons of division pixels used for object area detection according to the third embodiment of the present invention.

FIG. 19 is a slew showing the positional relationship between images obtained by division pixels at different positions.

FIGS. 20A, 20B and 20C are views for explaining an object range estimation method according to the third embodiment of the present invention.

FIG. 21 is a flowchart showing as object range estimation according to the third embodiment of the present invention.

FIG. 22 is a view showing an example of positions of division pixels used for object detection according to a modification of the third embodiment of the present invention.

FIG. 23 is a block diagram showing the arrangement of an image pickup apparatus according to the fourth embodiment of the present invention.

FIG. 24 is a flowchart showing an object range estimation according to the fourth embodiment of the present invention.

### DESCRIPTION OF THE EMBODIMENTS

Various exemplary embodiments, features, and aspects of the present invention will be described in detail below with reference to the drawings.

### First Embodiment

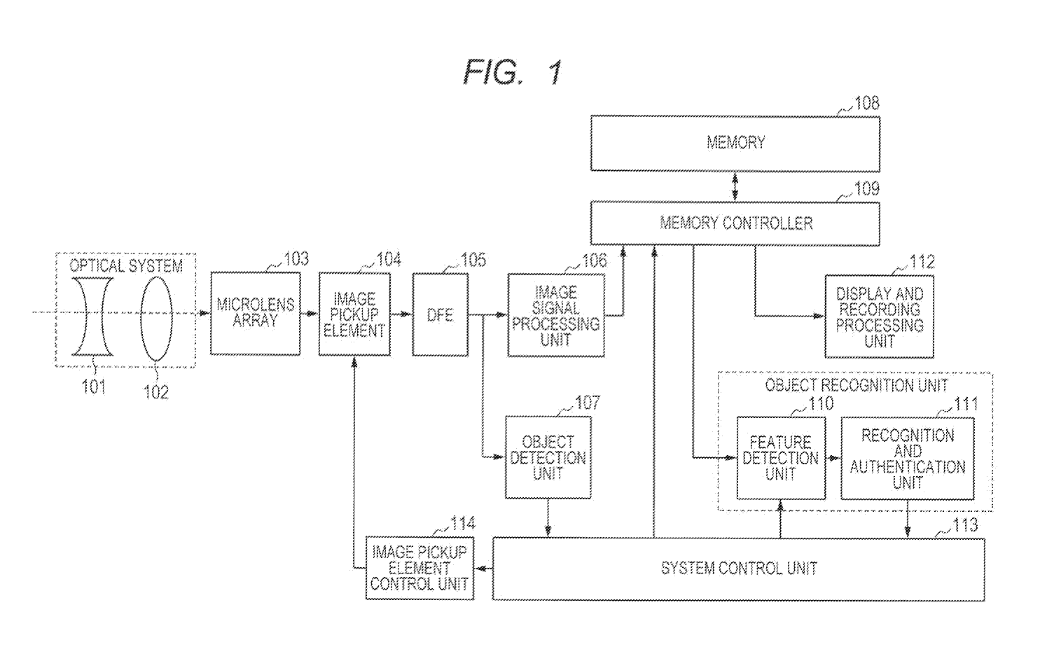

FIG. 1 is a block diagram stewing the overall arrangement, of an LF camera as an example of an image pickup apparatus according to the first embodiment of the present invention.

Referring to FIG. 1, the LF camera includes a room lens 101 and a focus lens 102 which constitute a photographing optical system. The LF camera also includes an MLA 103, an image pickup element 104 such as a CMOS, and an interface unit 105 between the image pickup element 104 and various kinds of signal processing units. The LF camera also includes an image signal processing unit 106 that processes an pickup signal (pixel signal) from the image pickup element, an object detection unit 107, and a main memory 108 such as a DRAM that temporarily stores data processed by each signal processing unit. Note that each functional block snares the main memory 108 and transfers each signal processing data via the main memory 108. A memory controller 109 serves as the control unit, of the main memory 108. A feature detection unit 110 reads out the pixel data of an. area detected by the object detection unit 107 from image data (photographing picture image) temporarily held in the memory 108 from the image signal, processing unit 106, and extracts the features of the object. For example, when the detection target is a human, parts (ears, eyes, nose, mouth, and the like) in the face are extracted. A recognition and authentication unit ill analyses the features of the object detected by the feature defection unit 110, and specifies, for example, the presence/absence of a smile or the individual. An object other than a human is also usable. The feature detection unit 110 extracts the features (color, shape, and the like) of a detected object, and the recognition and authentication unit 111 recognizes the object.

An image data display and recording processing unit 112 reads out image data held in the main memory 108, records the image data in a recording medium (not shown), and displays the image on a display unit (not shown) and a frame for designating an object in the photographing image. A system control unit 113 controls the entire image pickup apparatus. The system control unit 113 controls the units by loading programs stored in a memory (not shown) and executing the programs. The programs include the control program of the image pickup operation of the image pickup apparatus according to the present invention to be described below. The image pickup apparatus of the present invention operates under the control of those programs unless otherwise specified. An image pickup element control unit (sensor control unit) 114 controls readout of a pixel signal obtained by causing the image pickup element 104 such as a CMOS to photoelectrically convert an optical image.

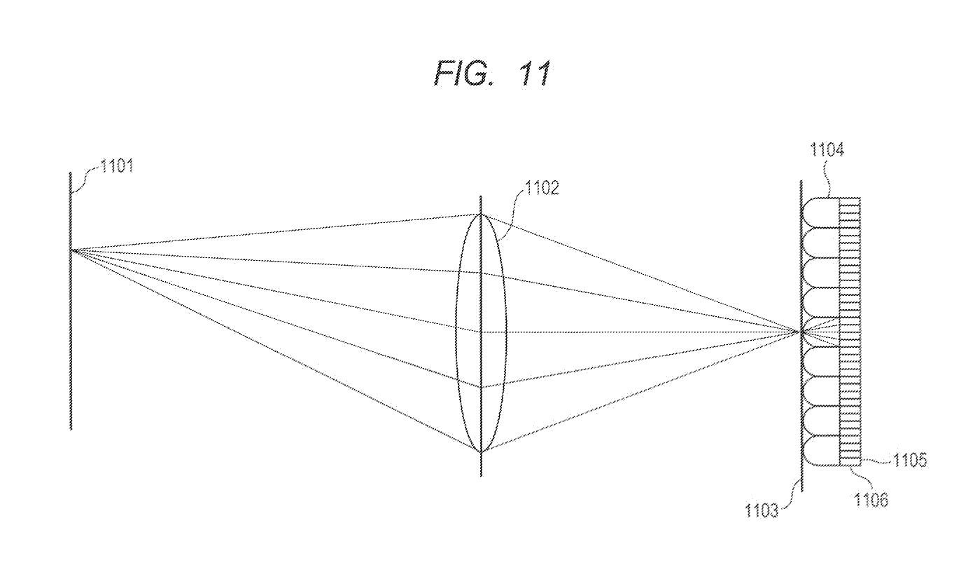

The photographing optical system is formed from the zoom lens 101 and the focus lens 102. The photographing optical system condenses light from an object and inputs it to the MLA 103. The focus lens 102 projects light from each point of the object to one of the microlenses of the MLA 103. That is, the image pickup apparatus according to this embodiment is an image pickup apparatus caving the function of the LF camera shown in FIG. 11. Note that the structures of the MLA 103 and the image pickup element 104 in the LF camera are already known, and a description thereof will be omitted here.

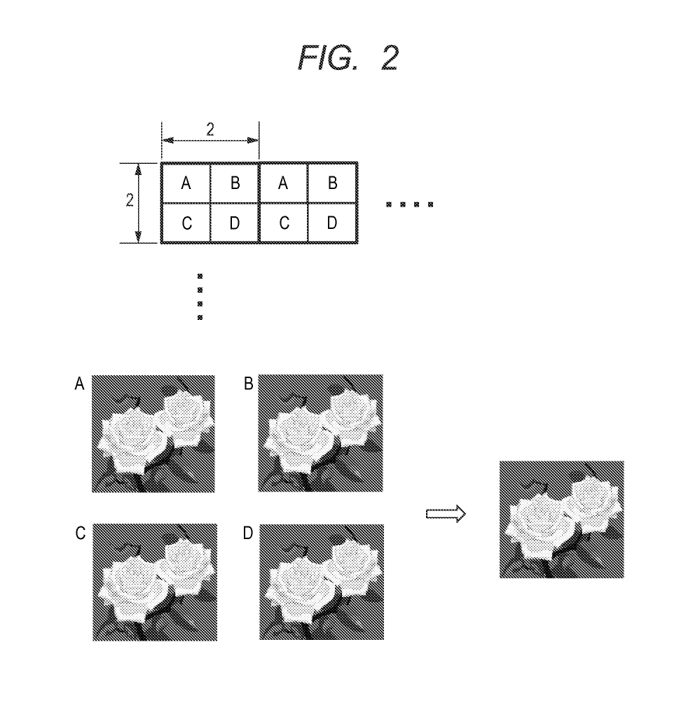

FIG. 2 is a view showing the division pixels of the image pickup element included in the image pickup apparatus having the function of the LF camera shown in FIG. 1 and an example of an image photographed by the image pickup element. A plurality of pixels arranged in a two-dimensional array on the image pickup element 104 are divided on a unit basis of a 2×(4 division) division block correspondingly to rue MLA 103, and the pickup signals of the pixels included m each division block are processed as LF data. In this case, four types of rays enter one division block of the image pickup element 104, and four types (A to D) of images of different parallaxes are obtained. As a result, when reproducing the recorded image, four types of depths of field are available, and the refocusing range can be adjusted in four steps. Note that the division block need not always be a 2×2 division block. For example, the division block may be a 4×4 division (16 division) block, as will he described later, or include another predetermined number of division pixels. This is a design choice matter of the image pickup element 104 and the MLA 103.

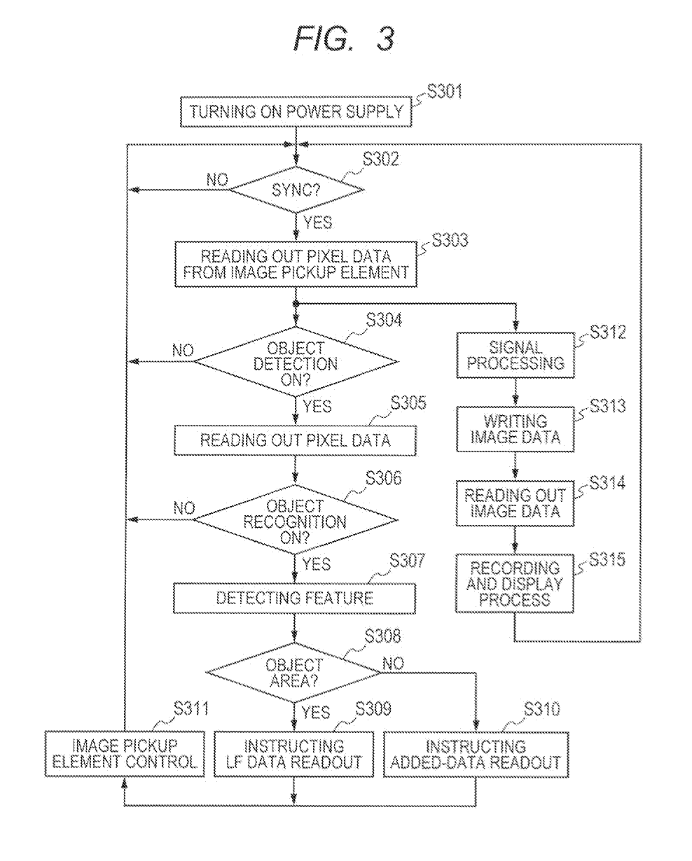

FIG. 3 is a flowchart snowing the image pickup operation of the image pickup apparatus according to this embodiment. This operation is performed by causing the system control unit 113 to execute the control program.

After the power supply is turned on (step S301), the system control unit 113 detects the synchronization signal of the image pickup system (step S302) and starts each processing operation (for example, detects a vertical synchronization signal and starts an image pickup operation process). First, the image pickup element control unit 114 reads out pixel signals from the linage pickup element 104 (step S303), and the image signal processing unit 106 processes the pixel signals (step S312). Parallel to the image signal process, the system control unit 113 determines ON/OFF of the object detecting function (step S304). If the object detecting function is OFF, the process waits until synchronization of the image pickup system is detected for the start of the next image frame (step S302).

If the object detecting function is ON in step S304, the feature detection unit 110 detects, based on the object detection result, a detection area in which an object is detected in the photographing frame, and reads out pixel data corresponding to the detection area from the memory 106 (step S305). Note that although the detection area is a rectangular area in this embodiment, the present invention is not limited to this.

When the object detecting function is ON, the system control unit 113 also determines ON/OFF of a function of recognizing the state of the detected object (step S306). If the object recognizing function is ON, the feature detection unit extracts the features of the object from rue pixel data of the rectangular area read cur from the memory 100 (step S307), and authenticates and recognizes the object is tee rectangular area (step S303).

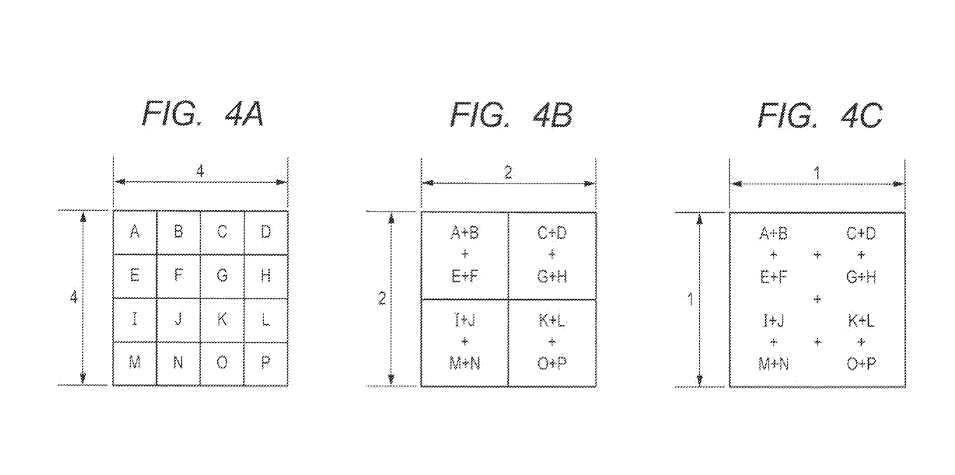

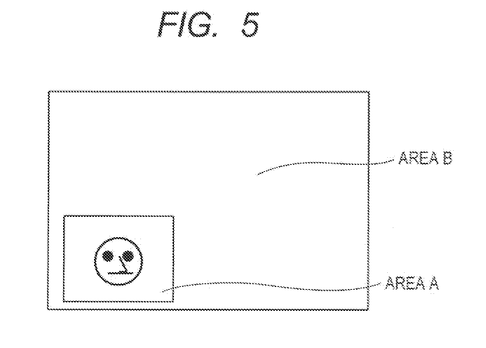

FIG. 5 shows an example of a detection area A in which the object detection unit detects an object. The system control unit 113 gives an instruction to read out line pixel signals or 4×4 division (16 division) pixels or the image pickup element 104 shown in FIG. 4A in the detection area A where the object is authenticated and recognized (step S309), and controls the image pickup element control unit 114 (step S311). The readout pixel signals are converted into LF data by the image signal processing suit 106.

The readout pixel signals undergo various kinds of signal processes by the image signal processing unit 106 (step S312) and are written in the memory 103 as LF data (step S313).

For an area B other than the detection area a where toe object is authenticated and recognized, as shown in FIG. 4B, adjacent pixels or 4×4 division pixels of the image pickup element 104 are added and read out from the image pickup element 104 as the pixel signals of 2×2 division (4 division) pixels. The system control, unit 113 gives the image pickup element control unit 114 such an instruction (step S309), and controls the image pickup element control unit 114 (step S311). The readout pixel signals undergo various kinds of signal processes by the image signal processing unit 106 (step S312) and are written in the memory 108 as LF data (step S313).

The display and recording processing unit 112 reads out the image data written in she memory 108 at a desired timing (step S314), records the image data in a recording medium (not shown), and displays the image on a display unit (not shown) (step S315).

In this embodiment, when reproducing the thus recorded image, 16 types of depths or field are available, and the refocusing range can be adjusted in 16 steps in the detection area A where the object is authenticated and recognized.

Additionally, in this embodiment, four types of depths of field are available, and the refocusing range can be adjusted in four steps in the area (area B) other than the detection area A where the object is authenticated and recognized.

As described above, in the detection area where the object is authenticated and recognized, the signals of division pixels obtained by dividing one pixel of the image pickup element 104 corresponding to an ML into 4×4 divisions (16 divisions) are read out from the image pickup element 104. On the other hand, in the area other than the detection area where the object is authenticated and recognized, adjacent pixels of the division pixels obtained by dividing one pixel of the image pickup element 104 corresponding to an ML into 4×4 divisions (16 divisions) are added and read out from the image pickup element 104 as the pixel signals of 2×2 division (4 division) pixels. This makes it possible to, when reproducing the recorded image told the refocusing range at the time or reproduction or the recorded image of the desired object (in this embodiment, the object in the area A) and, for the recorded image other than that of the object, reduce the amount of image data to be processed. Hence, the capacity of the memory for storing she pixel data can also be reduced. Note that the addition readout instruction can be done not only for switching from 4×4 to 2×2 but also for, for example, switching to 1×1 (without division). This can appropriately be set in accordance with the reduction amount of the pixel data.

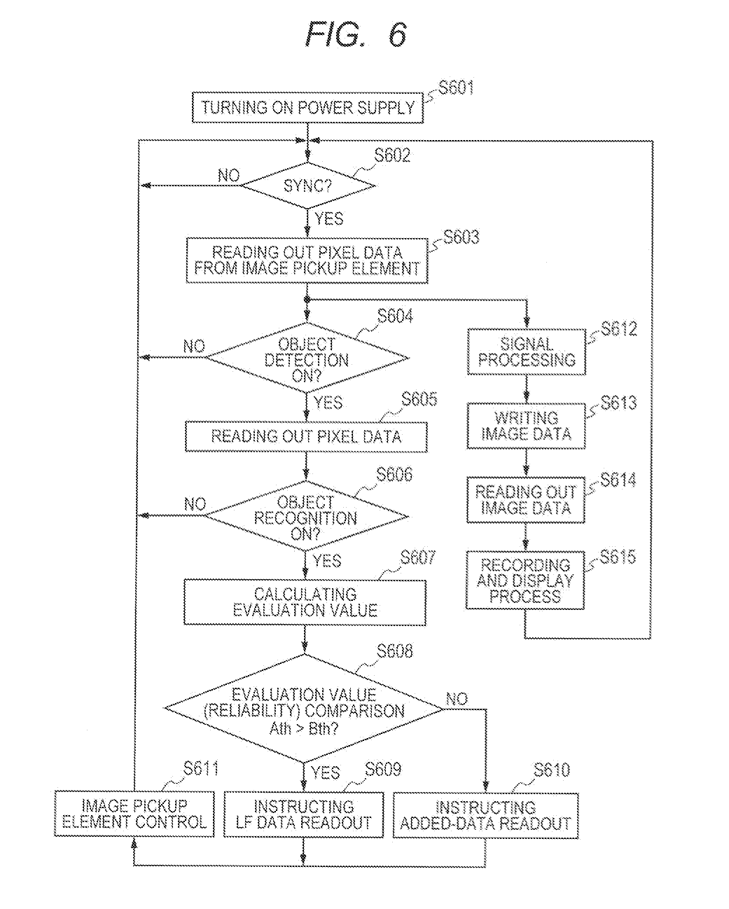

FIG. 6 is a flowchart showing the image pickup operation of the image pickup apparatus according to this embodiment when a plurality of objects are detected at the time of photographing. This operation is also performed by causing the system control unit 113 to execute the control program.

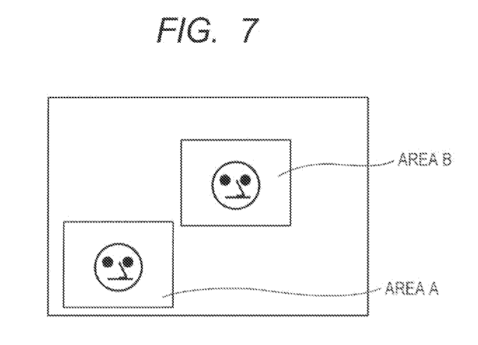

In this embodiment, an example in which two objects exist at the time of photographing, as shown in FIG. 7, will be explained.

After the power supply is turned on (step S601), the system control unit 113 detects the synchronization signal of the image pickup system (step S602) and starts each processing operation (for example, detects a vertical synchronization signal and starts an image pickup operation process). As the various kinds of processes of the image pickup system, first, the image pickup clement control unit 114 reads cut pixel signals from the image pickup element 104 (step S603), and the image signal processing unit 106 processes the pixel signals (step S612). Parallel to the image signal process, the system control unit 113 determines ON/OFF of the object defecting function (step S604). If the object defecting function is OFF, the process waits until synchronization of the image pickup system is detected for the start of the next image frame (step S602).

If the object, detecting function is ON in step S604, the feature detection unit 110 detects, based on the object detection result, a detection area in which an object is detected in the photographing frame, and reads out the pixel data of the detection area from the memory 108 (step S605). Note that although the defection area is a rectangular area in this embodiment, the present invention is not limited to this.

In this embodiment, pixel data corresponding to the rectangular areas (A and B) in which the two objects are detected in one photographing frame are read out from the memory 108 (step S605).

The feature detection unit 110 extracts the features of the objects from the two readout rectangular areas, and authenticates and recognizes the objects (step S606). The feature detection unit 110 then calculates the evaluation value (for example, reliability of recognition) of each detection area based on the resale or authentication and recognition, of the object (step S607).

After that, the calculated evaluation values of the defection areas are compared (step S608). Assume that the evaluation value in the rectangular area A (for example, reliability Ath of recognition) is larger than the evaluation value in the rectangular area B (for example, reliability Bth of recognition). This suggests that the object in the rectangular area A is the desired object at high possibility.

In this case, as for the pixel signals of the rectangular area A, the system control unit 113 gives an instruction to read out the pixel signals of 4×4 division (16 division) pixels of the image pickup element 104 shown in FIG. 4A (step S609), and controls the image pickup element control unit 114 (step S611). The readout pixel signals undergo various kinds of signal processes by the image signal processing unit 106 (step S612) and are written in the memory 108 as LF data (step S613). The display and recording processing unit 112 reads out the pixel data, written in the memory at a desired timing (step S614), records the pixel data in a recording medium (not shown), and displays the image on a display unit (not shown) (step S615).

As for the pixel signals of the rectangular area B, as shown in FIG. 4B, adjacent pixels of 4×4 division 16 division) pixels of one pixel of the image pickup element 104 are added and read out from the image pickup element 104 as the pixel signals of 2×2 division (4 division) pixels. The system control unit 113 gives the image pickup element control unit 114 such an instruction (step S610), and controls the image pickup element control unit 114 (step S611). The readout pixel signals undergo various kinds or signal processes by the image signal processing unit 106 (step S612) and are written in the memory 108 (step S613). The display and recording processing unit 112 reads out the pixel data written in the memory 108 at a desired timing (step S614), records the pixel data in a recording medium (not shown) and displays the image on a display unit (not shown) (step S615).

In an area other than the rectangular areas A and B, as shown it FIG. 4C, adjacent pixels of 4×4 division (16 division) pixels of one pixel of the image pickup element 104 are added and read out from the image pickup element 104 as LF data in 1×1 division (without division). The system control unit 113 thus controls the image pickup element control unit 114. The readout pixel signals undergo various kinds of signal processes by the image signal processing unit 106 (step S612) and are written in the memory 108 (step S613). The display and recording processing unit 112 reads out the pixel data written in the memory 108 at a desired timing (step S614), records the pixel data in a recording medium (not shown), and displays the image on a display unit (not shown) (step S615).

As described above, when there exist a plurality of detection areas where objects are authenticated and recognized, the amount of pixel signals of 4×4 division (16 division) pixels of one pixel of the image pickup element 104, which are to be read out from the linage pickup element 104, is changed in accordance with the evaluation value of the detection result of each object. For example, switching is performed to add adjacent pixels of 4×4 division pixels and road out the pixel signals as the pixel signals of 2×2 division pixels, or further add adjacent pixels and read out the pixel signals as the pixel signal of a 1×1 division (without division) pixel. This makes it possible to, for a desired object, hold the relocating range at the time of reproduction of the recorded image, and for an object other than the desired object, reduce the amount of pixel data. As a result, the capacity of the memory for storing the pixel data can also be reduced.

In this embodiment, when a plurality of objects are detected, for example, the user may view the photographed image on a display panel or the like formed from a touch panel or the like and select a desired object from the plurality of objects, instead of determination by the evaluation value. In this case as well, the pixel, signals are read out as the pixel signals of 4×4 division pixels in the selected object area, and as the pixel signals of 2×2 division pixels or a 1×1 division pixel in the unselected area, as described above.

Alternatively, when a plurality of objects are detected, the addition configuration may be switched in accordance with the position of the detection area. For example, for a detection area closest to the center of one frame image, the pixel signals are read out as the pixel signals of 4×4 division pixels. For other detection areas, adjacent pixels of 4×4 division pixels are added and read out as the pixel signals of 2×2 division pixels or a 1×1 division pixel.

For detection areas Paving the same object detection evaluation value, the addition configuration (pixel data reduction amount) may be switched depending on whether the position is closer to the center of one frame image.

### Second Embodiment

The second embodiment of the present invention will be described next with reference to the flowchart of FIG. 8.

FIG. 8 is a flowchart showing an image pickup operation according to this embodiment. This operation is also performed by causing a system control unit 113 to execute a control program. Note that the arrangement of the image pickup apparatus is the same as in the first embodiment, and a description thereof will be omitted here.

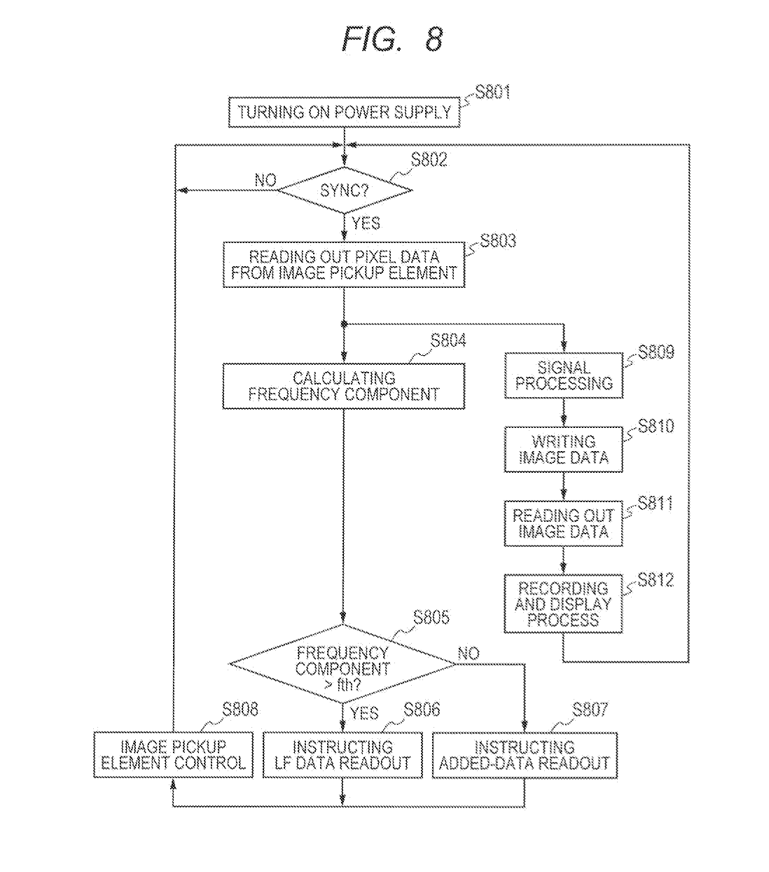

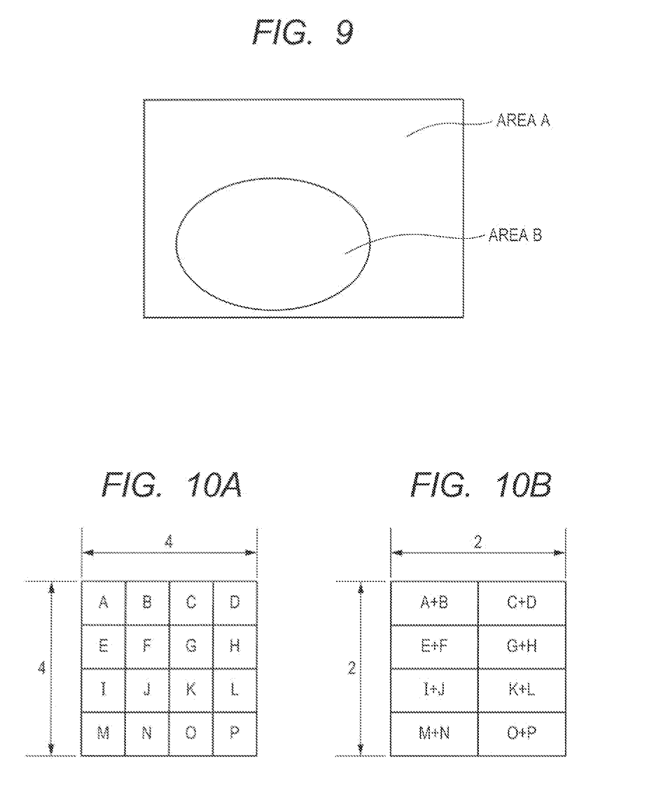

After the power supply is turned, on (step S801), the system control unit 113 defects the synchronization signal of the image pickup system (step S802) and starts each process leg operation (for example, detects a vertical synchronization signal and starts a processing operation). First, pixel signals are read out from an image pickup element such as a CMOS sensor (step S803). The frequency components of the readout pixel signals of one frame are calculated (step S804). Each calculated frequency component is compared with a threshold (fth) (step S805). In accordance with the frequency component comparison result, for example, the pixel signals of one frame are divided into two pixel signals of areas A and B, as shown in FIG. 9. dose that in this embodiment, this function is imparted to an object detection unit 107. However, it may be imparted to an image signal processing unit 106.

For an area in which the calculated frequency components are larger than the threshold (fth) (area B in FIG. 9, that is, the frequency components in the pixel data of one frame are high), one pixel of an image pickup element 104 is read cue as the pixel signals of 4×4 division (10 division) pixels. The system control unit 113 gives such a readout instruction (step S806), and controls en image pickup element control unit 114 (step S808). The readout pixel signals undergo various kinds of signal processes by the image signal processing unit 106 (step S809) and are written in a memory 108 (step S810).

For an area in which the calculated frequency components are equal to or smaller than the threshold (fth) (area A in FIG. 9, for example, sky in the scene), as shown in FIG. 4B, adjacent pixels of 4×4 division pixels of one pixel of the image pickup element 104 are added and read out as 2×2 division (4 division) pixels. The system control unit 113 gives such a readout instruction (step S807), and controls the image pickup element control unit 114 (step S808). The readout pixel signals undergo various kinds of signal processes by the image signal processing unit 100 (step S803) and are written in the memory 108 (step S810).

A display and recording processing unit 112 reads out the pixel data written in the memory 108 at a desired timing, records the pixel data in a recording medium (not shown), and displays the image on a display unit (not shown).

When pixel data is recorded in accordance with this embodiment, in the area where the frequency components are high out of the pixel data of one frame, 16 types of depths of field are available, and the refocusing range can be adjusted in 16 steps at the time of image reproduction.

In the area where the frequency components are low out of the pixel data of one frame, the pixel signals of 4×4 division pixels of one pixel of the image pickup element 104 are read out as 2×2 division pixels by adding adjacent pixels. Hence, in the area, where the frequency components are low out of the pixel data of ores frame, the amount of pixel data to be processed can be reduced, and the capacity of the memory for storing the pixel data can also be reduced.

When calculating frequency components in the pixel date of one frame, horizontal frequency components and vertical frequency components may be calculated and compared. For example, when the vertical frequency components are higher, out of the 4×4 division pixels of one pixel of the image pickup element 104, two horizontal pixels may be added (2 division), and the vertical pixels may be read out without being added, as shown in FIG. 10B. That is, the horizontal and vertical frequency components may be compared, and the pixel addition amount, may be increased in the direction in which the frequency components are lower. If the horizontal and vertical frequency components mainly include frequency components lower than a predetermined threshold, the pixel addition amount may be increased for each component.

As described above, according to the present invention, it is possible to provide an image pickup apparatus capable of reducing the amount of LF data to be processed by the image signal processing unit while holding the ref ceasing range at the time of ref causing of a recorded image as much as possible.

### Modification

A modification of the above-described first or second embodiment of the present invention will be described next.

The object area detected in the first embodiment or the object in the area divided in the second embodiment may be formed from be data outside the area (peripheral area including the area boundary) in the refocusing image process. In this case, the refocusing image process may be impossible in accordance with the reduction amount at the time of reading oat the pixel data. In this modification, to solve this problem, in the area near the boundary of the object area, the data of division pixels existing at positions with a long baseline length in a unit pixel ceil are read out from the memory 108, instead of performing addition readout, thereby enabling refocusing.

FIG. 13 is a view for explaining an area to read out the data of division pixels existing at positions with a long baseline length. Referring to FIG. 13, an area 1300 (rectangular area indicated by a black frame in FIG. 13) is an area in which an object is detected. Each gray-colored area indicated by a dotted frame is a peripheral area 1310 as a pixel data readout target according to this modification. The peripheral area is set with a width b. The width X can variably be controlled, as will be described later.

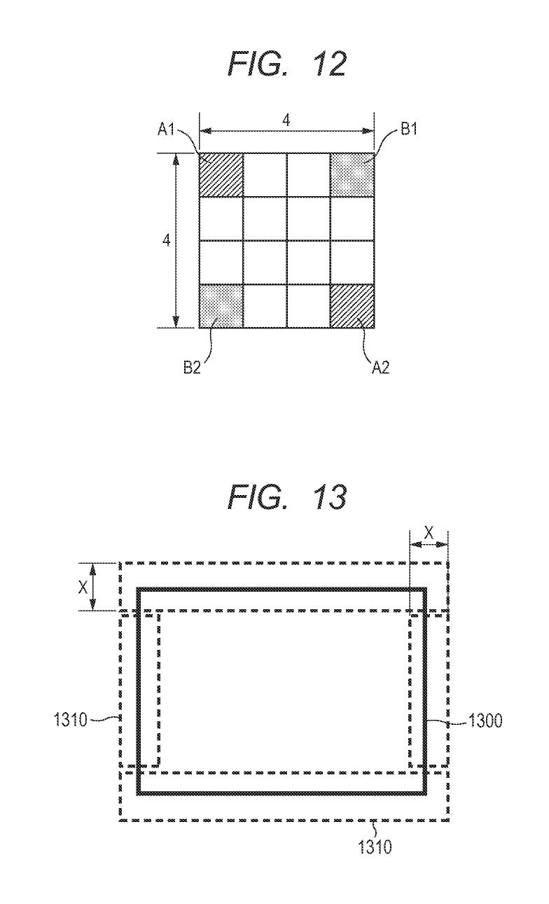

A configuration for reading out pixel data from the set peripheral areas 1310 will be described next with reference to FIG. 12. In the peripheral areas, for example, as shown in FIG. 12, in a unit pixel cell existing under an ML, the pixel data (A1 and A2) of hatched portions of LF data of 4×4 division (16 division) pixels or the pixel data (B1 and B2) of gray portions are read out from the memory 108. That is, the pixel data of each division pixel of a division pixel pair having the longest baseline length out of the LF data divided into the unit pixel cell is read out from the memory 108.

Note that in the modification of the first embodiment, the amount of pixel data read out from the memory 108 in the peripheral areas can be changed in accordance with the reliability of object detection. This is because when reading out, from the memory 108, pixel data existing as pixel positions with the long baseline length at the boundary between the object area and the area outside it, the range to read out the pixel data is controlled by changing the width X of the peripheral area. For example, when the reliability of object detection is low, the distance X is increased, and when the reliability of object detection is high, the distance X is decreased, thereby controlling LF data around the rectangular area to be used for refocusing. Note that the function of setting the peripheral area based on the reliability can be assigned to either the object detection unit 107 or the image signal processing unit 106. In the modification of the second embodiment, the size of the peripheral area may be changed between the horizontal direction and the vertical direction, in accordance with comparison between the horizontal frequency components and the vertical frequency components, as in, for example, control of the pixel data reduction amount described with reference to FIG. 10B.

As described shove, according to the modification, near the boundary between the object area and the area outside it, pixel data existing at pixel positions wish a long baseline length are read out from the memory 108. This can further increase the possibility of refocusing for the object within the object area.

Note that in the above-described embodiments and modification of the present invention, control of the entire apparatus performed by the system control unit 113 can be performed either by one piece of hardware or by causing a plurality of pieces of hardware to share the process.

### Third Embodiment

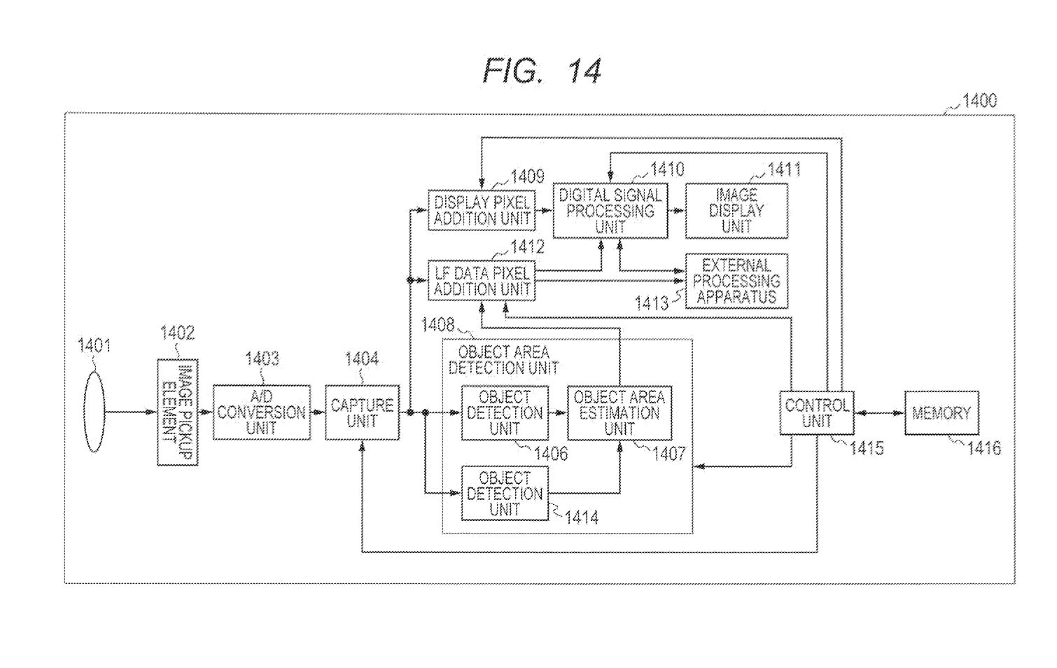

FIG. 14 is a block diagram showing the arrangement of an image pickup apparatus 1400 according to the third embodiment of the present invention. Note that the units of this image pickup apparatus are controlled by causing a CPU (not shown) for the control to execute programs stored in a memory (not shown). This embodiment also provides an image processing configuration for controlling the redaction amount of IF data in an area other than an object area, as in the above-described first and second embodiments.

Referring to FIG. 14, an optical system unit 1401 is formed from an optical lens group including a focusing lens used to adjust focusing, a shutter, an iris, and a lens control unit, and driven based on the output of a driving control unit (not shown).

An image pickup element 1402 has an MLA arranged in front of it as a pupil dividing means and a two-dimensional array or unit pixel cells corresponding to the respective MLs. The exposure amount is controlled by the shutter included in the optical system unit 1401 that constitutes a photographing optical system. The image pickup element 1402 picks up an optical image formed by the optical system unit 1401 by photoelectric conversion, and at the time of readout control, sequentially outputs charges accumulated in division pixels formed in each unit pixel to an A/D conversion unit 1403.

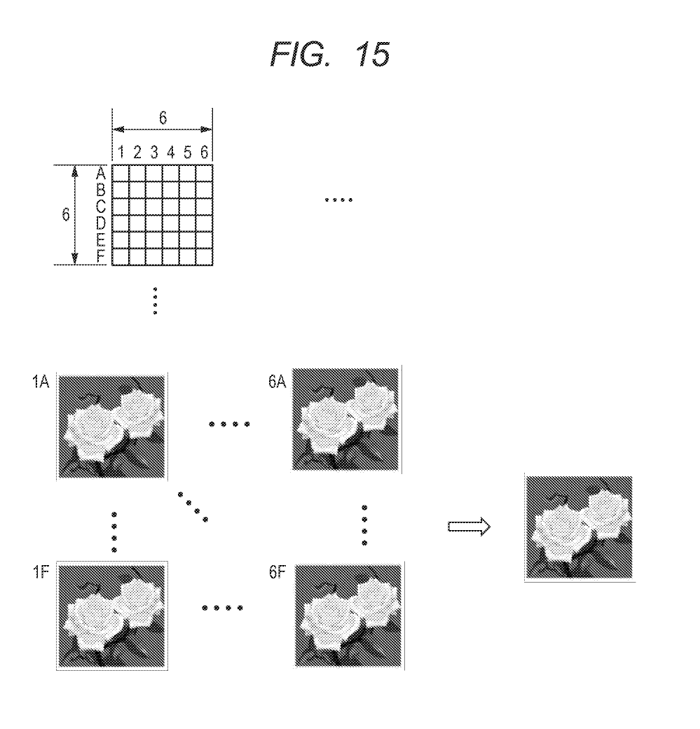

The unit pixel cell will be described here with reference to FIG. 15.

Referring to FIG. 15, the unit pixel cell includes 6×6 division pixels that share one ML included in the MLA serving as a pupil dividing unit. Such unit pixel cells are two-dimensionally arranged in the Bayer array on the image pickup element. Note that fee division pixels in the unit pixel ceil are represented by 1A, 6F, and the like using the numbers and symbols shown in FIG. 15.

A two-dimensional image formed by only division pixels existing at the same pixel position in the respective unit pixel, cells has a parallax with respect to a two-dimensional image formed by only division pixels existing at another same pixel position. That is, an image formed by only division pixels 1A of the respective unit pixel ceils and en image formed by only division pixels 2A of the respective unit pixel cells have different parallaxes. That is, a total of 36 different parallax images are obtained from the 6×6 division pixels.

An LF camera generally obtains a refocus image by compositing (re-forming) the pixels of different parallaxes corresponding to the number of division pixels. The principle to obtain the refocus image mill briefly be described with reference to FIG. 2. When the images are composited to obtain an image having no parallax at the position of the flower, an image at the position of the flower appears being in-focus. However, an image at position of leaves appears being blurred since images having parallaxes are added. In addition, when the images are composited to obtain an image having no parallax at the position of the leaves, an image at the position of the leaves appears being in-focus. However, an imago at position of the flower appears being blurred.

Such a refocusing enable range is determined in accordance with the number of division pixels. That is, a refocus image in the light field is an image obtained by compositing the division pixels. The image as the refocus target formed by the division pixels need to be at least in focus. This indicates that when addition readout from the image pickup element is performed, the image obtained by the pixels read out by the addition readout has a shallow depth of field, and the refocusing enable range accordingly becomes narrow.

Referring back to FIG. 14, the A/D conversion unit 1403 converts the analog electrical signal (pixel signal) output from the image pickup element 1402, which has undergone an analog signal process by an analog signal processing unit, into a digital electrical signal (pixel data) and outputs it to a capture unit 1404. Note that the analog signal processing unit includes a CDS circuit for removing noise on the transmission line and a nonlinear amplification circuit.

The capture unit 1404 determines the validated period and type of the pixel data, and outputs the division pixels 1A to 6F to an object area detection unit 1408, a display pixel addition unit 1409, and an LF DATA pixel addition unit 1412 as LF data.

To generate the image at a position actually existing on the focal plane of the focus lens in the optical system unit 1401, the display pixel addition unit 1409 adds the division pixels in the input unit pixel ceils and outputs the result to a digital signal processing unit 1410. Thus adding the division pixels in the unit pixel cells makes it possible to obtain an image having a shallow depth of field on the focal plane based on the actual focus lens position.

Next, the digital signal processing unit 1410 performs digital signal processes represented by a coincidence process, a gamma process, and a noise reduction process for the image input in the Bayer array, and outputs the image to an image display unit 1411. The digital signal processes such as a coincidence process, a gamma process, and a noise reduction process are known, and a detailed description thereof will be omitted here.

The image display unit 1411 displays the two-dimensional image generated by the digital signal processing unit 1410 to the user via a display apparatus represented by an LCD (Liquid Crystal Display).

The LF DATA pixel addition unit 1412 compresses the data amount of the LF data by adding the division pixels for a range within which no object exists in accordance with the output of the object, area detection unit 1408, and outputs the data, to an external recording apparatus 1413. The LF data may be recorded in a built-in memory such as a memory 1416. Note that as the pixel addition, the pixels may be added to obtain one pixel data for a range within which no object exists, or the 6×6 division pixels may be added two by two to form 3×3 division pixels. The pixel addition may be done for each area, and information representing the coordinates of an OIL corresponding to each data of the LF data may be attached as meta data. In this case, the number of pixels added in a range within which no object exists is made larger than the number of pixels added in a range within which an object exists.

A control unit 1415 is, for example, a CPU that performs operations noon receiving instructions from the units in the image pickup apparatus 1400, and controls the units by control signals. Note that the display pixel addition unit 1409, the digital signal processing unit 1410, and the LF DATA pixel addition unit 1412 correspond to the image signal processing unit 106 according to the first embodiment.

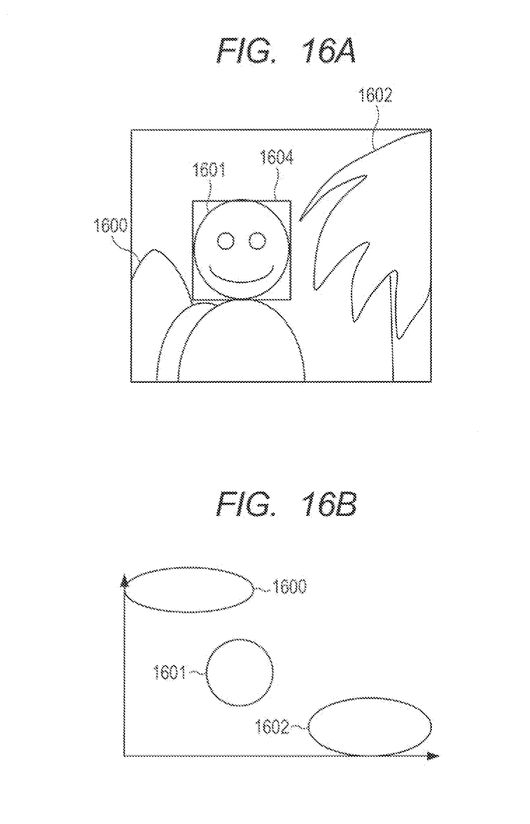

Pixel addition in an object area and that in an area other than the object area mill be described with reference to FIGS. 16A and 16B.

FIGS. 16A and 16B are views showing a photographed image including an object and a scene other than it at the time of image pickup. FIG. 16A shows the photographed image, and FIG. 16B is a bird's eye view.

Referring to FIGS. 16A and 16B, a mountain (scene) 1600 exists on the background behind an object 1601, and a tree 1602 exists on the near side of the object. An object area 1604 is set by recognizing (detecting) the object and represents the range of the object 1601. In general, the user's purpose is to make the object area 1604 capable of refocusing. For this reason, as long as all the LF data of the object area 1604 in focus are held, the Lb data of the remaining portions may be added to compress the LF data amount.

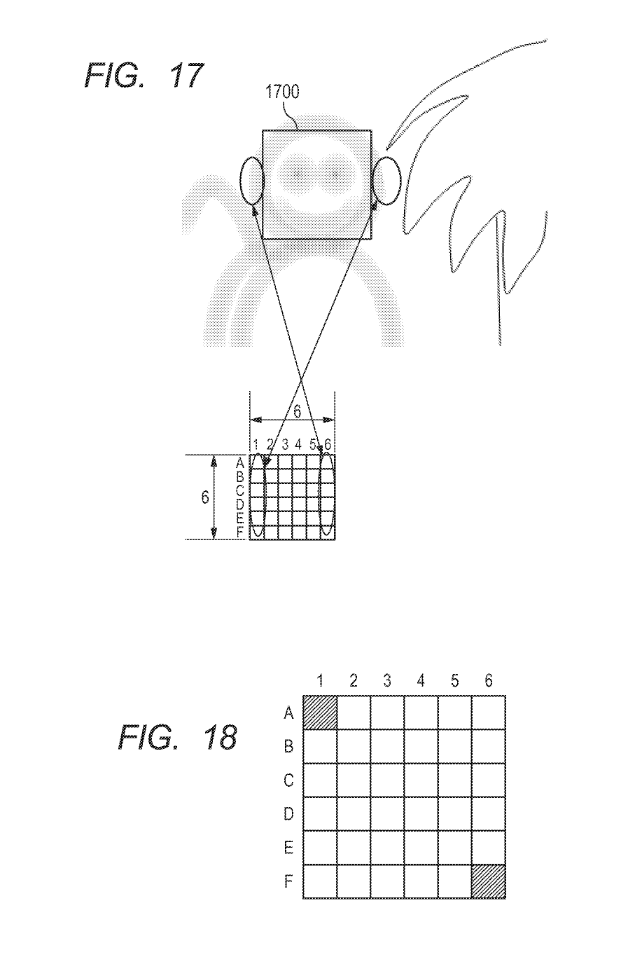

However, if an object area 1700 is detected with being out of focus, as shown in FIG. 17, and LF data only within the range of the object area 1700 is saved without addition, there may be possibility that information necessary for refocusing to the object area 1700 is reduced.

That is, although the frame of the object area 1700 roughly designates a face position, there exists a portion in which a blurred lace is located outside the range of the object area 1700. The area that is blurred and located outside the object area indicates than the division pixels existing near the center of each unit pixel cell nave no information of the object 1601, but some of the division pixels nave the information of the object 1601. This indicates that if the LF data only within the range of the object area 1700 is saved as non-added data, information necessary for a refocusing process to the object area 1700 is lost. To prevent this, it is necessary to more accurately estimate the range within which the object information exists on the image pickup unit (on the pupil dividing means).

The object area detection unit 1408 includes two object defection units 1406 and 1414. An object area estimation unit 1407 estimates a data range including object information existing on the LF data based on the outputs of the two object detection units 1406 and 1414, and cutouts the result to the LF DATA pixel addition unit 1412. The object area detection unit 1408 corresponds to the object detection unit 107, the feature detection unit 110, and the recognition end authentication unit 111 according to the first embodiment.

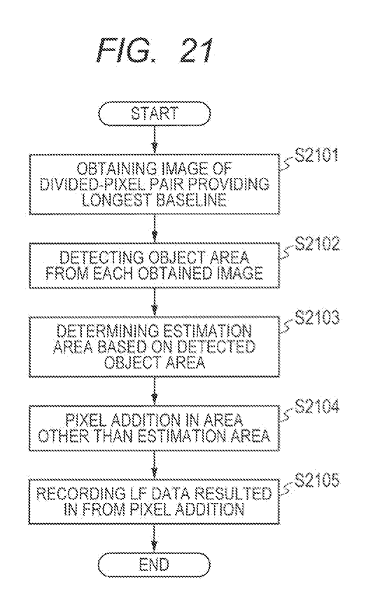

The operation of each block in object area detection and pixel addition according to this embodiment will be described in detail with reference to the flowchart of FIG. 21. Note that she operation of each block in the flowchart of FIG. 21 is performed by, for example, causing the control unit 1415 of the image pickup apparatus according to this embodiment to execute the program stored in the memory 1416.

Referring to FIG. 21, each of the object detection, units 1406 and 1414 recognizes an object in an input parallax image, and outputs an subject detection area set for the thus obtained object to the object area estimation unit 1407. Note that in this embodiment, a human face is detected as the object recognition method. However, the object need not always be a human and may be, for example, a flower or a pet. Note that the object recognition technique is known, and a description thereof will be omitted in this embodiment.

Input images to the object detection units 1406 and 1414 will be described with reference to FIG. 18.

FIG. 18 shows a unit pixel cell existing under an ML, like FIG. 15. The hatched portions indicate division pixels of a division pixel pair having the longest baseline length in the unit pixel cell.

In this embodiment, a parallax image pair formed by the pixels of the division pixel pair at the positions having the longest baseline length out of the division pixels in the unit pixel cell are selected and input to the object detection units 1406 and 1414, respectively (step S2101). This selection is based on the fact that the object area in an image of division pixels existing inside the division pixel pair having the long baseline length is located inside the object area detected from the image of the division pixels corresponding to the longest baseline length. This will be described in more detail with reference to FIG. 13.

A blurred image can be considered as an image obtained by adding images formed by division pixels in focus at the same position. At this time, the image of an end of the blurred image is obtained by an image located on the endmost division pixel. When two two-dimensional images obtained from the pixel positions of the hatched portions in FIG. 18 are overlaid on the blurred image shown in FIG. 17, the image shown in FIG. 19 is obtained. The broken lines in FIG. 19 indicate the contour of a division image formed by division pixels at the position 6F, and the solid lines indicate the contour of a division image formed by division pixels act the position 1A. In this way, a combination of pixels having the longest baseline length is selected and input to tree object detection units 1406 and 1414, thereby detecting an area at an end of the blurred image of the object.

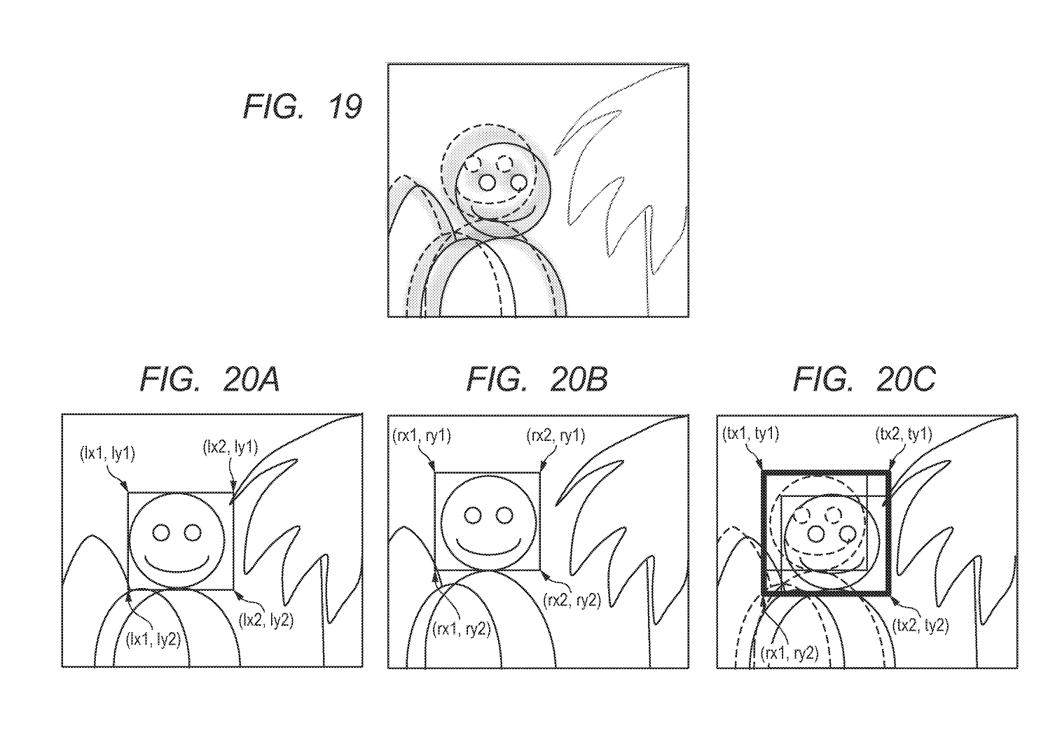

Each of the object detection units 1406 and 1414 detects the object area from the input image and outputs it to the object area estimation unit 1407 (step S2102). Assume that the object detection area output from the object detection unit 1406 has upper left-hand coordinates (1x1, 1y1), upper right-hand coordinates (1x2, 1y1), lower left-hand coordinates (1x1, 1y2), and lower right-hand coordinates (1x2, 1y2), as shown in FIG. 20A. Also assume that the object detection area output from the object detection unit 1414 has upper left-hand coordinates (rx1, ry1), upper right-hand coordinates (rx2, ry1), lower left-hand coordinates (rx1, ry1), and lower right-hand coordinates (rx1, ry1).

The object area estimation unit 1407 compares the coordinates 1x1 and 1y1 with the coordinates rx1 and ry1 in the pixel detection areas output from the object detection units 1406 and 1414, and selects the coordinates existing on the left side as tx1 and ty1. In addition, the object area estimation unit 1407 compares the coordinates 1x2 and 1y2 with the coordinates rx2 and ry2, and selects the coordinates existing on the right side as tx1 and ty2 (step S2103).

The upper left-hand coordinates (tx1, ty1), upper right-hand coordinates (tx2, ty1), lower left-hand coordinates (tx1, ty2), and lower right-hand coordinates (tx2, ty2) of the estimation area are determined from the selected coordinates tx1, 1y1, tx1, and ty2 and output to the LF DATA pixel addition unit 1412 (step S2104).

Estimation area coordinate determination (steps S2103 and S2104) will be described in detail with reference to FIGS. 20A to 20C.

FIG. 20A snows an image formed by the division pixels 1A output from the object detection unit 1406, and FIG. 20B shows an image formed by the division pixels 6F output from the object detection unit 1414. Coordinates shown in the drawings Faroe the above-described values. An object is detected from a two-dimensional image formed by the pixels of a division pixel pair with the longest baseline length, and the coordinates are compared, thereby accurately estimating the range of LF data including object information. Note that the coordinates in this embodiment are the coordinates of MLs on the sensor, that is, the coordinates of unit pixel cells. In the above-described example, an object area is estimated from a division pixel pair (parallax image pair) having the longest baseline length as a method of most effectively reducing data. However, the present invention is not limited to this. An area including an object area can also be estimated by defecting the object from a division pixel pair having a predetermined baseline length (parallax image pair having a predetermined parallax) and setting a relatively large predetermined width around the detected object area when estimating the object area. At this time, when the relatively large width of the object area is determined in consideration of she difference between a predetermined baseline length and the loosest baseline length in a plurality of parallax image pairs under the same microlens, the data reduction efficiency rises.

Next, the LF DATA pixel addition unit 1412 compresses the amount, of LP data by adding the division pixels for a range within which no object exists, in accordance with the coordinates of the object estimation area output from the object area estimation unit 1407, and outputs the data to the external recording apparatus 1413 (step S2105).

The external recording apparatus 1413 records the LF data that is the output of the LF DATA pixel addition unit 1412 in a memory card represented by an SD card (step S2106).

Note that when re-forming an image by refocusing, an image range that can be re-formed and an image range that cannot be re-formed exist. A filter process may be applied near the boundary to make the boundary line between the ranges unnoticeable.

In this embodiment, the capture data is directly input to the two object detection units 1406 and 1414. However, the capture data may be input to a single object detection unit. In this case, the capture data is temporarily arranged in a memory, and images formed by the pixels of the division pixel pair having the longest baseline length are divisionally input to the single object detection unit a plurality of times. This makes it possible to perform the same process as in this embodiment by a more compact arrangement.

In this embodiment, a case has been described in which two images by a division pixel pair having a long baseline length are used. However, the number of division pixels may be larger than two. For example, although the processing time becomes longer, four images formed by four division pixels not only at the positions 1A and 6F but also at the positions 1F and 6A may be used to estimate the area within which an object exists. Alternatively, 36 images formed by all the 36 division pixels existing in rows A to F and columns 1 to 6 may be used to estimate the area within which an object exists.

That is, any object estimation method is usable as long as it uses the fact that there is a combination of division pixels having a long baseline length, and the area of an object by division pixels existing inside the baseline length of the combination is located within the object area detected by the division pixels having the long baseline length.

In this embodiment, a process of reducing (compressing) the LF data amount is performed based on the estimated object area. However, the use example of the object area estimation method according to the present invention is not limited to this. For example, pixels corresponding to the estimated object area may be marked, or object information such as an object man based on the object area may be generated. The processing speed can be increased lay performing addition readout or thinning-out readout for an area other than the object area based on she object information when performing readout by an image process later. The data amount can also be reduced by changing a gradation process between the estimated object area and an area other than it and leaving the gradation (for example, 14 bits) of the object area more than the gradation (for example, 8 bits) of the area other than the object area. In addition, the estimated object area can be used when performing a predetermined image process for only the object area or changing a process between areas.

Note that in this embodiment, an LF camera of a plenoptic method has been explained. However, this embodiment can also be applied to an LF camera by a stereo camera. In this case, object detection is performed by selecting an image obtained by an optical lens having the longest baseline length out of a plurality of parallax images.

Note that in this embodiment, the LF DATA pixel addition unit 1412 adds pixels in accordance with the output frees the object area estimation unit 1407. However, the present invention is not limited to this. The addition process target need not always be the data read out from the image pickup element. For example, pixels may be added on the floating diffusion (FD) of the image pickup element and read out.

### Modification of Third Embodiment

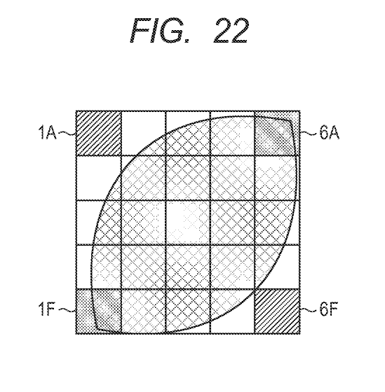

A modification of the third embodiment will be described with reference to FIG. 22. The arrangement of the image pickup apparatus is the same as in the third embodiment, and a description thereof will be omitted. Unlike the third embodiment, a combination of division pixels having a long baseline length is selected in considerate of occurrence of vignetting. Hence, the flowchart of the object range estimation operation according to this modification is basically the same as in the third embodiment (FIG. 21). Division pixel pair selection according to this modification will be describe below.

In the third embodiment, division pixels having the longest baseline length are selected out of the division pixels to estimate the object detection area without assuming the influence of shading caused by vignetting of the ions or image height. Generally, tee optical system unit 1401 has an area in which only attenuated light enters the image pickup element 1402 due to vignetting of the lens. For example, when vignetting occurs in the optical system unit 1401, the vignetting on the exit pupil is protected onto the division pixels. For this reason, incident light may be absent in a portion other than the halftone dot meshing portion in FIG. 22. In this case, the area within which the object exists cannot be estimated even if the division pixels 1A and 6F (hatched portions) having the longest baseline length are used, as in the third embodiment.

In the modification, in this case, the object is detected and the object area is estimated by selecting a division pixel pair having a long baseline length within the range without the influence of vignetting (depending on the vignetting shape), like the division pixels 1F and 6A (stipple portions). This makes it possible to estimate the object area without being affected by vignetting. The operations of detecting and estimating the object area from images by the pixels of the selected division pixel pair and adding the pixels comply with the flowchart of FIG. 21, as in the third embodiment.

### Fourth Embodiment

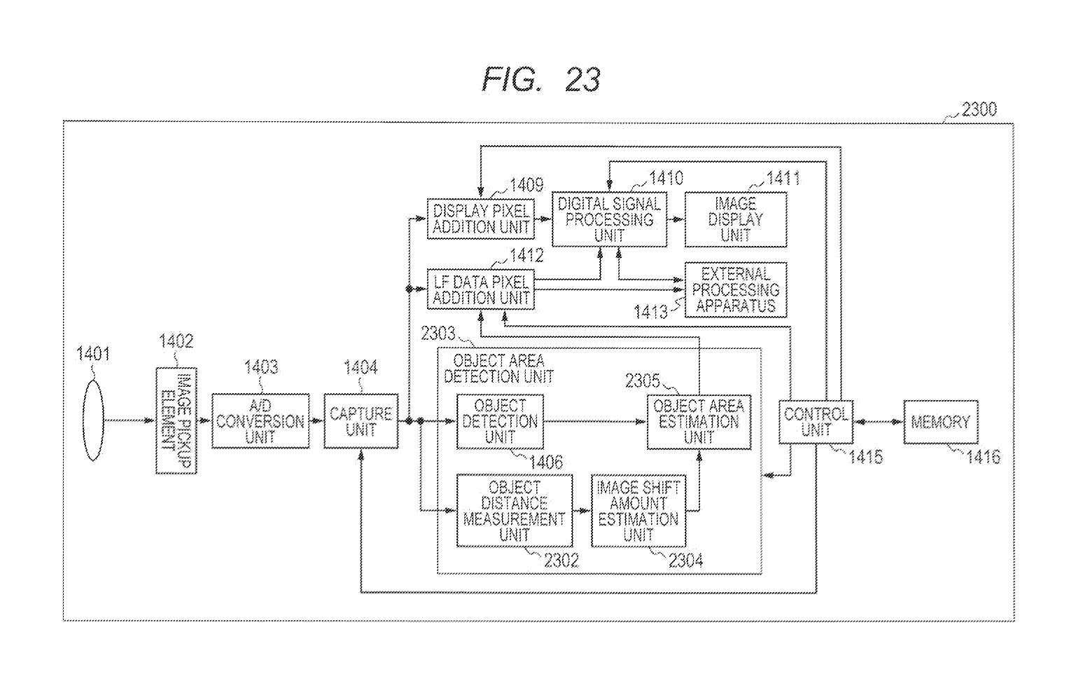

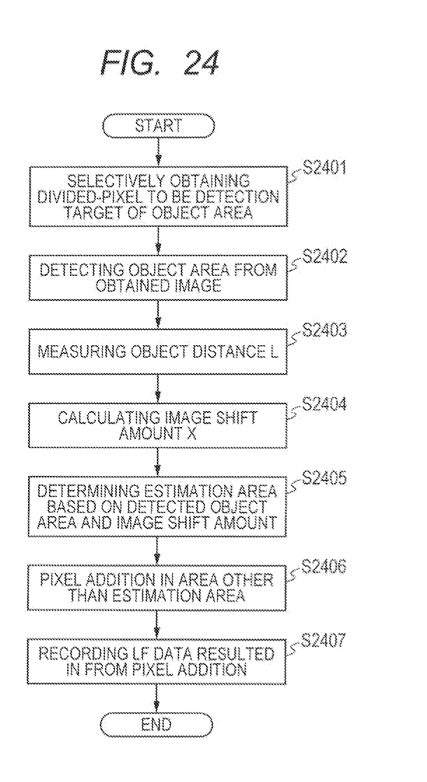

The fourth embodiment of the present invention, will be described next with reference to FIGS. 23 and 24. In the third embodiment and the modification thereof, a method of estimating an object area within which object information exists by performing object detection for an image by each of a plurality of division pixels having a long baseline length has been described.

In the third embodiment and the modification thereof, however, object detection needs to be done at least twice. It is therefore necessary to provide a plurality of object detection units or divisionally read out the division pixels from the DRAM a plurality of times. This leads to an increase in the cross or processing time.

In the fourth embodiment, considering this problem, an arrangement that estimates a range on an image pickup element within which object information exists by using only an area in which an object is recognize from an image generated by a single division pixel will be described.

FIG. 23 is a block diagram showing the arrangement of as image pickup apparatus according to this embodiment. The same reference numerals as in sire third embodiment denote the same parts in FIG. 23, and a description thereof will be emitted here.

An image pickup apparatus 2300 according to this embodiment includes an object area detection unit 2303. Tire remaining blocks are the same as those of the image pickup apparatus 1400 described in the third embodiment. The object area detection unit 2303 includes an object detection unit 1406, an object area estimation unit 2305, an object distance measurement unit 2302, and an image shift amount estimation unit 2304.

The operation of each block at the object area defection unit 2303 will be described m detail.

The object detection unit 1406 selectively inputs pixels at positions where the baseline length can be set long, like division pixels 1A, 1F, 6A, and 6F in FIG. 15, out of the division pixels existing under a microlens (step S2401). Note that when vignetting occurs, as described it the modification of the third embodiment, division pixels at pixel position where the baseline length can be set long within the tango in which there is little influence of vignetting may selectively be input.

The object detection unit 1406 detects the position of an object for a two-dimensional image formed by the input division pixels, and outputs the coordinates to the object area estimation unit 2305 (step S2402).

The object distance measurement unit 2302 measures a distance L to the object based on the input image and outputs the distance to the image shift amount estimation unit 2304 (step S2403). As the measurement method, any method capable of measuring the object distance is usable, such as a phase difference method based on the parallax between division pixels, a contrast method used in a normal compact digital camera, or a distance measurement method using an outer measurement sensor.

Next, the image shift amount estimation unit 2304 obtains the information of the distance L to the obtained object, a fecal length f of an optical system unit 1401, a baseline length B up to a pixel position having the longest baseline length with respect to the division pixel input to the object detection unit 1406, and a pitch p of the MLs of an image pickup element 1402. When the division pixel 1A is used by the object detection unit 1406, the pixel position of the counterpart of the division pixel pair having the longest baseline length is that of the division pixel 6F existing on the diagonal line. When the division pixel 1F is used, the counterpart is the division pixel 6A, and vice versa.

The image shift amount estimation unit 2304 calculates an image shift amount X by the following equation using the input distance L, the focal length f, the baseline length B, and the ML pitch p, and outputs the image shift amount X to the object area estimation unit 2305 (step S2404).

$$X = \frac{B \cdot f}{L \cdot p}$$

The object area estimation unit 2305 estimates an area within which object information exists on the image pickup element based on the image shift amount X, and outputs the result to an LF DATA pixel addition unit 1412 (step S2405). For example, the object detection area shown in FIG. 20B is obtained from the object detection area shown in FIG. 20A using the image shift amount X, and an area within which object information exists on the image pickup element is estimated from those detection areas, as in the third embodiment.

The LF DATA pixel addition unit 1412 compresses the LF data amount by adding the division pixels for a range within which no object exists in accordance with the coordinates of the object estimation area output from the object area estimation unit 2305, and outputs the LF data to an external recording apparatus 1413 (step S2406).

The external recording apparatus 1413 records she LF data that is the output of the LF DATA pixel addition unit 1412 in a memory card represented by an SD card (step S2407).

As described above, it is possible to more accurately estimate the area within which object information exists on the image pickup element while reducing the scale of the object detection unit and the number of times of detection by obtaining the image shift amount X.

According to the above-described present invention, it is possible to provide an image pickup apparatus capable of reducing LF data by specifying a microlens on an image pickup element having information of an object necessary for refocusing of a recorded image. Note that in the above-described embodiments, a target of addition processing for reducing an LF data amount is not necessary data which has been just read out from the image pickup element. For example, the LF data pixel addition unit 1412 may read out the LF data stored in the memory 1416 which has been photographed, through the control unit 1415.

### Other Embodiments

Embodiments of the present invention can also be realized by a computer of a system or apparatus that reads out and executes computer executable instructions recorded on a storage medium (e.g., non-transitory computer-readable storage medium) to perform rise functions of one or more of the above-described embodiment(s) of the present invention, and by a method performed by rise computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2013-000528, filed Jan. 7, 2013, 2013-178322, filed on Aug. 20, 2013, and 2013-246190, filed Nov. 20, 2013, which ere hereby incorporated by reference herein in their entirety.

What is claimed is:

1. An image pickup apparatus including an image pickup unit including a two-dimensional array of a plurality of pixels each of which converts an optical image into a pixel signal by photoelectric conversion, and a photographing optical system including a focus lens, and a microlens array formed from a plurality of microlenses arranged between the image pickup unit and the focus lens, each microlens corresponding to one of division blocks provided in case the two-dimensional array of the pixels is divided on a unit basis of a block including a predetermined number of pixels, comprising:
a readout unit configured to read cut the pixel signals from the plurality of pixels;
an object detection unit configured to detect an object included in a photographing picture image based on the pixel signals read out by the readout unit; and
a control unit configured to control the readout unit based on a result of object detection by the object defection unit, and controls a data reduction amount of the pixel signals read out from a division block corresponding to a defection area of the detected object in the photographing picture image and a data reduction amount of the pixel signals read out from a division block corresponding to an area other than the detection area.

2. An apparatus according to claim 1, wherein the control unit makes the data reduction amount of the pixel signals in the division block corresponding to she area other than the detection area larger than the data reduction amount of the pixel signals in the division block corresponding to the detection area of the defected object.

3. An apparatus according to claim 1, wherein when a plurality of objects are detected, the object detection unit calculates a reliability of each detected object, and the control unit controls the readout unit so as to control the data reduction amount of the pixel signals read out from the division block corresponding to the detection area of each object in accordance with the reliability.

4. An apparatus according to claim 3, wherein the control unit controls the readout unit so as to make the data reduction amount of the pixel signals in the detection area of the object having a low reliability larger than the data reduction amount of the pixel signals in the detection area of the object having a high reliability.

5. An apparatus according to claim 4, wherein in a case where there are detection areas having the same calculated reliability, the control unit controls the readout unit so a to control the data reduction amount of the pixel signals read out from the division block corresponding to each of the detection areas caving the same reliability in accordance with a position of the detection area.

6. An apparatus according to claim 1, wherein in a case where the object detection unit detects a plurality of objects, the control unit controls the readout unit so as to control the data reduction amount of the pixel signals read out from the division block corresponding to the detection area of each object in accordance with a position of she detection area.

7. An apparatus according to claim 6, wherein the control unit controls the readout unit so as to increase the data reduction amount of the pixel signals as a position of the detection area becomes far apart from a center of the photographing picture image.

8. An apparatus according to claim 1, further comprising a selection unit configured to select the detection area of the object detected by the object detection unit,
wherein the control unit controls the readout unit so as to control the data reduction amount of the pixel signals read out from the division block corresponding to the detection area of each object in accordance with whether the detection area is the detection area selected by the selection unit.

9. An apparatus according to claim 8, wherein the control unit controls the readout unit so as to make the data reduction amount of the pixel signals read out from the division block corresponding to the defection area selected by the selection unit smaller than the data reduction amount of the pixel signals read out from the division block corresponding to an unselected detection area.

10. An apparatus according to claim 1, further comprising a dividing unit configured to divide the photographing picture image into a plurality of areas corresponding to different frequency components based on frequency components of the pixel signals,
wherein the control unit controls the readout unit so as to control the data reduction amount of the pixel signals read out from the division block corresponding to each of the divided areas in accordance with the different frequency components.

11. An apparatus according to claim 12, wherein the dividing unit calculates frequency components in different directions in each of the divided areas, and
the control unit controls the readout unit so as to control the data reduction amount of the pixel signals read out from the division block corresponding to each of the divided areas in accordance with a direction in which a high frequency component is calculated.

12. An apparatus according to claim 1, wherein the control unit controls the readout unit so as to add the pixel signals of a predetermined number of pixels included in the division block and read out the pixel signals and control the data reduction amount of the pixel signals try changing the number of pixels to be added.

13. An apparatus according to claim 1, further comprising:
an image signal processing unit configured to obtain light field data by processing the pixel signals read out by the readout unit under the control of the data reduction amount by the control unit; and
a recording unit configured to record the light field data in a recording medium.

14. A control method of an image pickup apparatus including an image pickup unit including a two-dimensional array of a plurality or pixels earn of which converts an optical image into a pixel signal by photoelectric conversion, and a photographing optical system including a focus lens and a microlens array formed from a plurality of microlenses arranged between, the image pickup unit and the focus lens, each microlens corresponding to one of division blocks provided in case the two-dimensional array of the pixels is divided on a unit basis of a block including a predetermined number of pixels, comprising:
a readout step of reading out the pixel signals from the plurality of pixels;
an object defection step of detecting an object included in a photographing picture image based on tine pixel signals read out in the readout step; and
a control step of controlling the readout step based on a result of object detection in the object detection step, and controls a data reduction amount of the pixel signals read out from a division block corresponding to a detection area of the detected object in the photographing picture image and a data redaction amount or the pixel signals read out from a division block corresponding to an area other than the detection area.

15. A non-transitory computer-readable storage medium storing a program for controlling an image pickup apparatus including an image pickup unit including a two-dimensional array of a plurality of pixels each of which converts an optical image into a pixel signal by photoelectric conversion, a photographing optical system including a focus lexis and a microlens array formed from a plurality of microlenses arranged between the image pickup unit and the focus lens, and a readout unit configured to read out the pixel signals from the plurality of pixels, each microlens corresponding to cue of division blocks provided in case the two-dimensional array of the pixels is divided on a unit basis of a block Including a predetermined number of pixels, the program comprising a code for causing a computer to function as:
object detection means for detecting an object included in a photographing picture image based on the pixel signals read out by the readout unit; and
control means for controlling the readout unit based on a result of object detection by the object detection means, and controls a data reduction amount of the pixel signals read out from a division block corresponding to a detection area of the detected object in line photographing picture image and a data reduction amount of the pixel signals read out from a division block corresponding to en area other than the detection area.

16. An image processing apparatus for processing image data of a plurality of parallax images picked by an usage pickup apparatus including an image pickup unit and a photographing optical system capable of picking up the plurality of parallax images, comprising:
an obtaining unit configured to obtain the image data;
a readout unit configured to read oat the pixel signals corresponding to the plurality of pixels;
an object detection unit configured to detect an object included in a photographing picture image based on the pixel signals read out by the readout unit; and
a control unit configured to control the readout unit based on a result of object detection by the object detection unit, and controls a data reduction amount of the pixel signals read out from a division block corresponding to a detection area or the detected object in the photographing picture image end a data reduction amount of the pixel signals read out from a division block corresponding to an area other than the detection area.

17. A control method of an image processing apparatus for processing image data of a plurality of parallax images picked by an image pickup apparatus including an image pickup unit and a photographing optical system capable of picking up the plurality of parallax images, comprising:
a readout step of reading out the pixel signals corresponding to toe plurality of pixels;
an object detection step of detecting an object included is a photographing cloture image based on the pixel signals read out in the readout step; and
a control step or controlling the readout step based on a result of object detection in the object detection step, and controls a data reduction amount of the pixel signals read out from a division block corresponding to a detection area of the detected object in the photographing picture image and a data reduction amount of the pixel signals read out from a division block corresponding to an area other than the detection area.

18. A non-transitory computer-readable storage medium storing a program for controlling an image processing apparatus for processing image data of a plurality of parallax usages picked by an image pickup apparatus including an image pickup unit and a photographing optical system capable of picking up the plurality of parallax images, the program comprising a code for causing a computer to function as:
object detection means for detecting an object included in a photographing picture image based on the pixel signals read out by the readout unit; and
control means for controlling the readout unit based on a result of object detection by the object detection means, and controls a data redaction amount of the pixel signals read out from a division block corresponding to a detection area of the detected object in the photographing picture image and a data redaction amount of the pixel signals read out from a division block corresponding to an area other than the detection area.
